(19) United States
(12) Patent Application Publication
(10) Pub. No.: US 2017/0236616 A1
(43) Pub. Date: Aug. 17, 2017

(54) MULTI-CORE CABLE

(71) Applicant: SUMITOMO ELECTRIC INDUSTRIES, LTD., Osaka (JP)

(72) Inventor: Tatsunori HAYASHISHITA, Aomori (JP)

(73) Assignee: SUMITOMO ELECTRIC INDUSTRIES, LTD., Osaka (JP)

(21) Appl. No.: 15/416,424

(22) Filed: Jan. 26, 2017

(30) Foreign Application Priority Data
Jan. 28, 2016 (JP) 2016-013986

(51) Int. Cl. H01B 7/00; H01B 7/02; H01B 7/29; H01B 3/28; H01B 7/04; H01B 11/20; H01B 7/18

(52) U.S. Cl. CPC H01B 7/0009; H01B 11/20; H01B 7/02; H01B 7/18; H01B 3/28; H01B 7/04; H01B 7/292

(57) ABSTRACT

A multi-core cable includes a plurality of coaxial wires, each coaxial wire including a center conductor whose sectional area is 0.0005 mm² to 0.0039 mm². The multi-core cable includes a resin tape wrapped around the coaxial wires so that all of the plurality of coaxial wires are included therein, a shield layer being made of metal and covering the resin tape, and a sheath covering the shield layer and arranged at an outermost layer of the multi-core cable. The sheath is made of thermoplastic vulcanizate or tetrafluoroethylene-propylene-based fluorine containing rubber.

### CROSS-REFERENCE TO RELATED APPLICATION

The present application claims priority from Japanese Patent Application No. 2016-013986 filed on Jan. 28, 2016 the entire content of which is incorporated herein by reference.

### BACKGROUND

Technical Field

The present invention relates to a multi-core cable having a plurality of coaxial wires or insulated wires.

Related Art

Patent Document 1 discloses a multi-core cable having a center part at which first coaxial cables are arranged in a multi-layer construction of a concentric circle, a peripheral part at which second coaxial cables are arranged around the center part, and a sheath formed at an outer side of the peripheral part.

### [Patent Document 1] Japanese Patent Application Publication No. 2009-196289A

In a multi-core cable having a plurality of coaxial cables, as disclosed in Patent Document 1, it is needed to satisfy desired heat resistance, voltage withstand and high flexibility.

### SUMMARY

The present invention provides a multi-core cable capable of satisfying desired heat resistance, voltage withstand and high flexibility.

A multi-core cable according to the present invention comprises:

a plurality of coaxial wires, each coaxial wire including a center conductor whose sectional area is 0.0005 mm² to 0.0039 mm², a plurality of insulated wires, each insulated wire including a conductor whose sectional area is 0.0005 mm² to 0.0039 mm² or the plurality of coaxial wires and the plurality of insulated wires;

a resin tape wrapped around the coaxial wires or the insulated wires so that all of the plurality of coaxial wires, all of the plurality of insulated wires or all of the plurality of coaxial wires and the plurality of insulated wire are included therein;

a shield layer being made of metal and covering the resin tape, and

a sheath covering the shield layer and arranged at an outermost layer of the multi-core cable,

wherein the sheath is made of thermoplastic vulcanizate or tetrafluoroethylene-propylene-based fluorine containing rubber.

According to the present invention, it is possible to provide the multi-core cable capable of satisfying the desired heat resistance, voltage withstand and high flexibility.

### BRIEF DESCRIPTION OF THE DRAWINGS

FIG. 1 is a sectional view depicting an example of a multi-core cable in accordance with an exemplary embodiment of the present invention.

FIG. 2A is a sectional view depicting an example of a first coaxial wire unit arranged at a center layer of the multi-core cable shown in FIG. 1.

FIG. 2B is a sectional view depicting an example of a second coaxial wire unit arranged at a peripheral layer of the multi-core cable shown in FIG. 1.

### DETAILED DESCRIPTION

### Description of Exemplary Embodiment of Present Invention

First, an exemplary embodiment of the present invention will be described.

(1) A multi-core cable according to the exemplary embodiment of the present invention comprises:

a plurality of coaxial wires, each coaxial wire including a center conductor whose sectional area is 0.0005 mm² to 0.0039 mm², a plurality of insulated wires, each insulated wire including a conductor whose sectional area is 0.0005 mm² to 0.0039 mm² or the plurality of coaxial wires and the plurality of insulated wires;

a resin tape wrapped around the coaxial wires or the insulated wires so that all of the plurality of coaxial wires, all of the plurality of insulated wires or all of the plurality of coaxial wires and the plurality of insulated wire are included therein;

a shield layer being made of metal and covering the resin tape, and

a sheath covering the shield layer and arranged at an outermost layer of the multi-core cable,

wherein the sheath is made of thermoplastic vulcanizate or tetrafluoroethylene-propylene-based fluorine containing rubber.

According to a configuration of the exemplary embodiment, it is possible to provide a multi-core cable capable of satisfying desired heat resistance, voltage withstand and high flexibility.

(2) It is preferable that a total number of the coaxial wires and the insulated wires accommodated in the resin tape is 6 to 300, and a thickness of the sheath is 0.1 mm to 0.3 mm.

It is possible to make a diameter of the multi-core cable small while maintaining the favorable heat resistance and voltage withstand.

### Details of Exemplary Embodiment of Present Invention

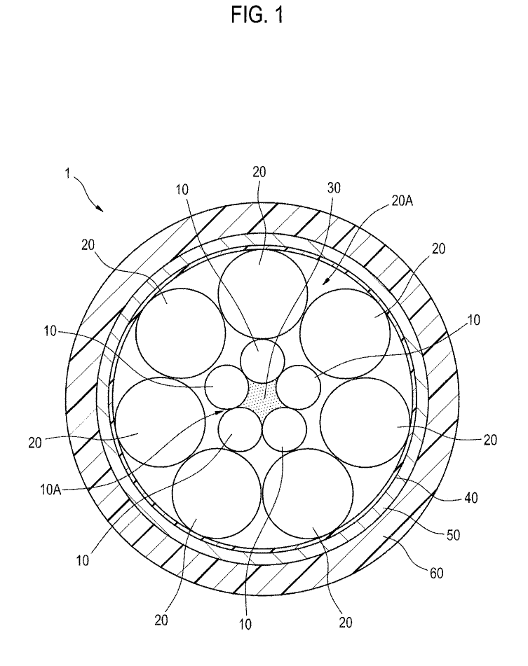

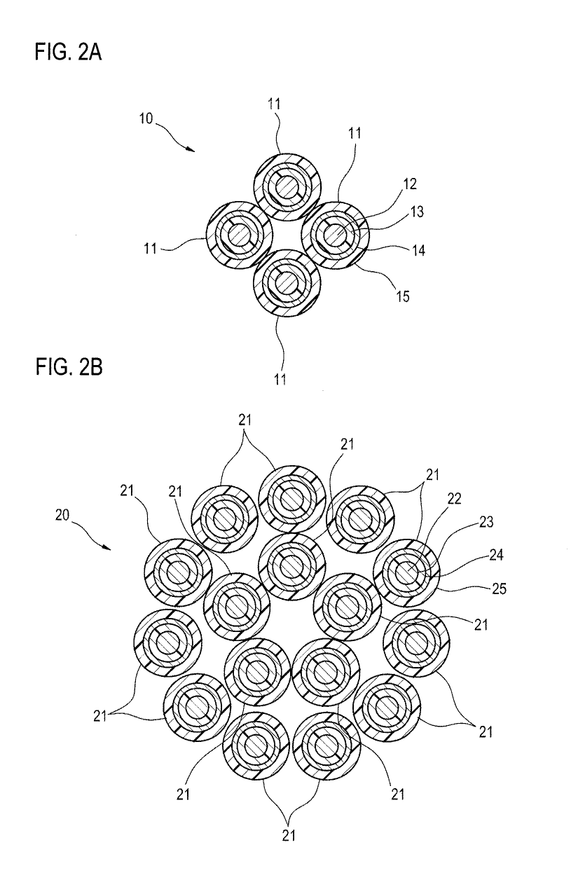

Hereinafter, an example of the exemplary embodiment of the multi-core cable of the present invention will be described with reference to the drawings. FIG. 1 is a sectional view of a multi-core cable of the exemplary embodiment, FIG. 2(A) is a sectional view of a first coaxial wire unit arranged at a center layer, and FIG. 2(B) is a sectional view of a second coaxial wire unit arranged at a peripheral layer.

As shown in FIG. 1, a multi-core cable 1 of the exemplary embodiment has a center layer 10A having first coaxial wire units 10 each including a plurality of coaxial wires, which will be described later, and a peripheral layer 20A arranged around the center layer 10A and having second coaxial wire units 20 each including a plurality of coaxial wires, which will be described later. Also, the multi-core cable 1 has a resin tape 40 covering the peripheral layer 20A, an outer shield layer 50 (an example of the shield layer) covering the resin tape 40, and a sheath 60 covering the outer shield layer 50.

The center layer 10A has a bundle of tensile strength fibers 30 (a tension member) arranged at a center thereof and the plurality of (five, here) first coaxial wire units 10 arranged in a circle shape around the bundle. Also, the peripheral layer 20A arranged at an outer side of the center layer 10A has the plurality of (seven, here) second coaxial wire units 20 arranged in a concentric circle shape with the center layer 10A.

As shown in FIG. 2A, each of the plurality of first coaxial wire units 10 arranged at the center layer 10A has a bundle of a plurality of (four, here) coaxial wires 11. That is, in the example, the center layer 10A has the five first coaxial wire units 10 each of which has the four coaxial wires 11, and has a total of the twenty coaxial wires 11.

Each coaxial wire 11 has a center conductor 12 arranged at a center thereof, an inner insulator 13 arranged at an outer side of the center conductor 12, an outer conductor 14 arranged at an outer side of the inner insulator 13, and an outer insulator 15 arranged at an outer side of the outer conductor 14. In the meantime, as the coaxial wire 11 of the example, a coaxial wire of which a sectional area of the center conductor 12 is 0.0005 mm² to 0.0039 mm² (AWG (American Wire Gauge) 32 to 49) is used.

As shown in FIG. 2B, each of the second coaxial wire units 20 arranged at the peripheral layer 20A has a bundle of a plurality of (sixteen, here) coaxial wires 21. That is, in the example, the peripheral layer 20A has the seven second coaxial wire units 20 each of which has the sixteen coaxial wires 21, and has a total of the 112 coaxial wires 21.

Each coaxial wire 21 has a center conductor 22 arranged at a center thereof, an inner insulator 23 arranged at an outer side of the center conductor 22, an outer conductor 24 arranged at an outer side of the inner insulator 23, and an outer insulator 25 arranged at an outer side of the outer conductor 24, like the coaxial wire 11 of the first coaxial wire unit 10. In the meantime, as the coaxial wire 21 of the example, a coaxial wire of which a sectional area of the center conductor 22 is 0.0005 mm² to 0.0039 mm² (AWG 32 to 49) is used.

The second coaxial wire unit 20 is formed by arranging the plurality of coaxial wires 21 in a multi-layer construction and twisting them. Meanwhile, in the example, the five coaxial wires 21 are arranged at a first layer and the eleven coaxial wires 21 are arranged at a second layer, so that one second coaxial wire unit 20 is formed by a total of sixteen coaxial wires 21, for example.

As shown in FIG. 1, the resin tape 40 is wrapped around the peripheral layer 20A. That is, the resin tape 40 is wrapped around the peripheral layer 20A so that all the coaxial wires 11, 21 configuring the multi-core cable 1 are included within the resin tape 40. In the meantime, the resin tape 40 can be formed of only resin or resin and metal. As the resin tape 40, a resin tape having a copper foil, an aluminum foil or the like adhered thereto or a resin tape having a metal material vapor-deposited thereto can be used, for example.

A thin metal wire is helically wrapped around the resin tape 40, so that the outer shield layer 50 is formed. The outer shield layer 50 may be formed by braiding the thin metal wire around the resin tape 40.

The sheath 60, which is the outermost layer covering of the multi-core cable 1, is covered around the outer shield layer 50. As a material of the sheath 60, thermoplastic vulcanizate (TPV) or tetrafluoroethylene-propylene-based (FEPM) fluorine containing rubber may be used. The TPV or FEPM fluorine containing rubber is used as the sheath 60, so that it is possible to provide the multi-core cable 1 of which any characteristic of heat resistance, voltage withstand and high flexibility is favorable.

Also, the sheath 60 of the example has preferably a thickness of 0.1 mm to 0.3 mm. When the thickness of the sheath 60 is smaller than 0.1 mm, it is not possible to maintain the high voltage withstand and heat resistance. On the other hand, when the thickness of the sheath 60 is greater than 0.3 mm, it is not possible to make a diameter of the multi-core cable 1 small and to maintain the flexibility. Therefore, when the sheath 60 is made to have the thickness of 0.1 mm to 0.3 mm, it is possible to make a diameter of the multi-core cable 1 small while maintaining the favorable voltage withstand and heat resistance.

In the meantime, the multi-core cable 1 shown in FIG. 1 has the 20 coaxial wires 11 and the 112 coaxial wires 21, i.e., a total of the 132 coaxial wires 11, 21. However, the numbers and arrangements of the coaxial wires 11, 21 and the numbers and arrangements of the first coaxial wire units 10 and the second coaxial wire units 20 are not limited to the above example. However, the total number of the coaxial wires 11, 21 is preferably 6 to 300. When the total number of the coaxial wires 11, 21 is smaller than six (6), it is not possible to apply the multi-core cable to a desired utility. When the number of the coaxial wires 11, 21 is greater than three hundreds (300), it is not possible to make a diameter of the multi-core cable 1 small.

### EMBODIMENTS

Embodiments of the multi-core cable 1 described in the above exemplary embodiment are described. Regarding the multi-core cable 1 (including the 100 coaxial wires), the heat resistance, the voltage withstand and the flexibility were evaluated while changing the material of the sheath 60. As the material of the sheath 60, thermoplastic vulcanizate (TPV) was used in an example 1, which is an embodiment, and FEPM fluorine containing rubber was used in an example 2, which is an embodiment. On the other hand, as the material of the sheath 60, polyvinyl chloride (PVC), silicone and fluorine resin (PFA), which have been conventionally used, were respectively used in examples 3 to 5, which are comparative examples. The thickness of the sheath is preferably 0.1 to 0.3 mm. The thickness of the sheath 60 smaller than 0.1 mm is disadvantageous in view of the voltage withstand of the cable. The thickness of the sheath 60 greater than 0.3 mm is disadvantageous in view of the flexibility of the cable.

### (Heat Resistance)

In the evaluation of the heat resistance, the tensile strength and the breaking elongation of the multi-core cable before heating were measured, the multi-core cable was left alone for 3 hours under environments of 145° C., and then the tensile strength and the breaking elongation of the multi-core cable after the heating were measured. When the tensile strength and the breaking elongation of the multi-core cable after the heating were greater than the tensile strength and the breaking elongation of the multi-core cable before the heating by above 85%, the corresponding multi-core cable was accepted (c), and when the tensile strength and the breaking elongation of the multi-core cable after the heating were greater than the tensile strength and the breaking elongation of the multi-core cable before the heating by 85% or less, the corresponding multi-core cable was rejected (x). The results are shown in Table 1.

### (Voltage Withstand)

In the evaluation of the voltage withstand, evaluation tests based on standard JIS C3005 or the like were performed. The multi-core cable of 5000 (ACV/1 min) or greater was accepted (∘), and the multi-core cable of below 5000 (ACV/1 min) was rejected (x). The results are shown in Table 1.

### (Flexibility)

In the evaluation of the flexibility, the bending moment (gf·cm), which was obtained when the multi-core cable was bent by 15°, was measured using a Stiffness Tester. The results are shown in Table 1. The measured cable of 100 cores (including 100 wires) was accepted (∘), i.e., regarded as high flexible when the bending moment was 150 gf·cm or less and was rejected (×) when the index was greater than 50. The results are shown in Table 1. On the other hand, the multi-core cable of 200 cores was regarded as flexible when the bending moment was 250 gf·cm or less, and the multi-core cable of 300 cores was regarded as flexible when the bending moment was 350 gf·cm or less.

TABLE 1

| | Example 1 | Example 2 | Example 3 | Example 4 | Example 5 |
|---|---|---|---|---|---|
| Sheath | TPV | FEPM | PVC | silicone | PFA |
| material | | fluorine | | | |
| | | containing | | | |
| | | rubber | | | |
| Heat | ∘ | ∘ | x | ∘ | ∘ |
| resistance | | | | | |
| Voltage | ∘ | ∘ | x | x | ∘ |
| withstand | | | | | |
| Flexibility | ∘ | ∘ | ∘ | ∘ | x |
| Overall | ∘ | ∘ | x | x | x |
| evaluation | | | | | |

As shown in Table 1, since the multi-core cables of the example 1 (TPV) and the example 2 (FEPM fluorine containing rubber), which are embodiments, passed all the evaluation items, they passed the overall evaluation, too. On the other hand, since the multi-core cables of the example 3 (PVC), the example 4 (silicone) and the example 5 (PFA), which are comparative examples, were rejected for some items, they were rejected for the overall evaluation, too. Specifically, in the example 3 (PVC), the multi-core cable was rejected for the heat resistance and the voltage withstand, in the example 4 (silicone), the multi-core cable was rejected for the voltage withstand, and in the example 5 (PFA), the multi-core cable was rejected for the flexibility. In the meantime, although not shown in Table 1, in the example 4 (silicone), the sheath was difficult to be thinned, too. From the above, it could be seen that the multi-core cable (examples 1 and 2) of the exemplary embodiment has the high flexibility while maintaining the heat resistance and the voltage withstand.

Although the present invention has been described in detail with reference to the specific exemplary embodiment, a variety of changes and modifications can be made without departing from the spirit and scope of the present invention.

In the exemplary embodiment, the multi-core cable 1 includes the plurality of coaxial wires 11, 21. However, some or all of the plurality of coaxial wires 11, 21 can be replaced with insulated wires. Herein, the insulated wire indicates a wire having a center conductor and a sheath covering the conductor. As the insulated wire, an insulated wire of which a sectional area of the conductor is 0.0005 mm² to 0.0039 mm² is preferably used. When a multi-core cable of a complex type including a coaxial wire of which a sectional area of the center conductor is 0.0005 mm² to 0.0039 mm² and an insulated wire of which a sectional area of a conductor is 0.0005 mm² to 0.0039 mm² has the same configuration as the exemplary embodiment, it is possible to obtain a multi-core cable having a small diameter and the favorable heat resistance, voltage withstand and high flexibility.

1. A multi-core cable comprising:
a plurality of coaxial wires, each coaxial wire including a center conductor whose sectional area is 0.0003 mm² to 0.039 mm², a plurality of insulated wires, each insulated wire including a conductor whose sectional area is 0.0003 mm² to 0.039 mm² or the plurality of coaxial wires and the plurality of insulated wires;
a resin tape wrapped around the coaxial wires or the insulated wires so that all of the plurality of coaxial wires, all of the plurality of insulated wires or all of the plurality of coaxial wires and the plurality of insulated wire are included therein;
a shield layer being made of metal and covering the resin tape, and
a sheath covering the shield layer and arranged at an outermost layer of the multi-core cable,
wherein the sheath is made of thermoplastic vulcanizate or tetrafluoroethylene-propylene-based fluorine containing rubber.

2. The multi-core cable according to claim 1, wherein a total number of the coaxial wires and the insulated wires accommodated in the resin tape is 6 to 300, and a thickness of the sheath is 0.1 mm to 0.3 mm.

3. The multi-core cable according to claim 1, wherein the sectional area of the center conductor of the coaxial wire is 0.0005 mm² to 0.0039 mm², and the sectional area of the conductor of the insulated wire is 0.0005 mm² to 0.0039 mm².
